(19) United States
(12) Patent Application Publication
(10) Pub. No.: US 2014/0261333 A1
(43) Pub. Date: Sep. 18, 2014

(54) ENGINE CONTROL SYSTEM HAVING A VARIABLE ORIFICE

(71) Applicant: ELECTRO-MOTIVE DIESEL, INC., La Grange, IL (US)

(72) Inventors: AAron G. Foege, Westmont, IL (US); David T. Montgomery, Edelstein, IL (US)

(73) Assignee: ELECTRO-MOTIVE DIESEL, INC., La Grange, IL (US)

(21) Appl. No.: 13/795,635

(22) Filed: Mar. 12, 2013

(51) Int. Cl. F02M 51/02

(52) U.S. Cl. CPC F02M 51/02
USPC 123/472

(57) ABSTRACT

A control system for an engine is disclosed. The control system may have a first gaseous-fuel injector configured to inject gaseous fuel into a first intake passage associated with at least a first cylinder and a second gaseous-fuel injector configured to inject gaseous fuel into a second intake passage associated with at least a second cylinder. The control system may also have a variable orifice disposed within the second intake passage upstream of the first gaseous fuel injector. The control system may additionally have a sensor configured to provide a signal indicative of a performance parameter of the engine and a controller electronically connected to the variable orifice and the sensor. The controller may be configured to move the variable orifice to adjust a ratio of air-to-fuel in the first and second intake passages based on the signal.

### TECHNICAL FIELD

The present disclosure is directed to an engine control system and, more particularly, to an engine control system having a variable orifice.

### BACKGROUND

Gaseous-fueled engines have developed into cost-efficient alternatives to diesel-only engines. These engines utilize a gaseous fuel, such as natural gas, alone or in combination with a liquid fuel, to produce mechanical output. A controlling aspect of gaseous-fueled engines is a ratio of air-to-fuel (air/fuel) in the mixture delivered to the engine cylinders for combustion. The air/fuel ratio affects engine performance, including the amount of power produced and the nature of the exhaust that is emitted. For some engines, the air delivery system is optimized for high engine output at higher loads at a specific air/fuel ratio. Without an ability to adjust the air delivery system, however, these gaseous-fuel engines may have difficulty running efficient air/fuel ratios at low loads, including during engine idling.

An example of an engine having a system capable of adjusting the air/fuel ratio is disclosed in U.S. Pat. No. 4,030,293 that issued to Hata on Jun. 21, 1977 (“the '293 patent”). The '293 patent discloses an engine with two groups of cylinders connected to an intake manifold. The engine includes a carburetor that feeds an air/fuel mixture through the intake manifold to the cylinders. The intake manifold includes a fence plate configured to obstruct flow of an air/fuel mixture to a first group of cylinders, thereby reducing flow of unvaporized fuel to those cylinders. The resulting flow reduction of unvaporized fuel produces a leaner air/fuel mixture that is delivered to the first group of cylinders and a richer air/fuel mixture that is delivered to the second group of cylinders.

While the system of the '293 patent may allow for some control over the air/fuel mixture delivered to different groups of cylinders, it may be less that optimal. In particular, the '293 patent is directed to controlling air/fuel mixtures that include unvaporized constituents, which may limit the usefulness of the system for gaseous-fueled engines. Further, the '293 patent is concerned with adjusting the air/fuel ratio to achieve a leaner mixture that reduces emissions. A leaner mixture, however, may not assist a gaseous-fueled engine at low loads where the mixture may already be too lean for the engine to run efficiently.

The present disclosure is directed to overcoming one or more of the problems set forth above and/or other problems of the prior art.

### SUMMARY

In a first aspect, the present disclosure is directed to a control system for an engine. The control system may include a first gaseous-fuel injector configured to inject gaseous fuel into a first intake passage associated with at least a first cylinder, and a second gaseous-fuel injector configured to inject gaseous fuel into a second intake passage associated with at least a second cylinder. The control system may also include a variable orifice disposed within the second intake passage downstream of the first gaseous fuel injector. The control system may additionally include a sensor configured to provide a signal indicative of a performance parameter of the engine and a controller electronically connected to the variable orifice and the sensor. The controller may be configured to move the variable orifice to adjust a ratio of air-to-fuel in the first and second intake passages based on the signal.

In another aspect, a method for controlling an air/fuel ratio of an engine is disclosed. The method may include directing charged air into a first intake passage and into a second intake passage in parallel. The method may also include injecting gaseous fuel into each of the first and the second intake passages. The method may additionally include moving a variable orifice to selectively restrict charged air flow through only the second intake passage and thereby affect the air/fuel ratio in both the first and second intake passages.

### BRIEF DESCRIPTION OF THE DRAWINGS

FIG. 1 is a schematic illustration of an exemplary disclosed power system; and

FIG. 2 is a schematic illustration of another exemplary disclosed power system.

### DETAILED DESCRIPTION

FIG. 1 illustrates a power system 10 having an engine 12. Power system 10 may include an intake system 14 configured to direct air and fuel into engine 12, an exhaust system 16 configured to direct exhaust away from engine 12, and a control system 18 configured to monitor and control intake system 14 and exhaust system 16. For the purposes of this disclosure, engine 12 is depicted and described as a gaseous-fueled engine, which may include an engine powered only by gaseous fuel (e.g., natural gas, methane, etc.) and a dual-fuel engine powered by a combination of gaseous fuel and liquid fuel (e.g., diesel). Engine 12 may include an engine block 20 that at least partially defines a plurality of cylinders 22. A piston (not shown) may be slidably disposed within each cylinder 22 to reciprocate between a top-dead-center position and a bottom-dead-center position, and a cylinder head (not shown) may be associated with each cylinder 22. Cylinder 22, the piston, and the cylinder head may form a combustion chamber 24. In the illustrated embodiment, engine 12 includes twelve such combustion chambers 24 arranged into a first bank 26 and a second bank 28 (e.g., arranged into a Vee-configuration). However, it is contemplated that engine 12 may include a greater or lesser number of combustion chambers 24 arranged into an inline-configuration or into any other conventional configuration, if desired.

Engine 12 may be a two-stroke, four-stroke, six-stroke, or other type of engine that runs at least partially on gaseous fuel. As the pistons cycle between power, exhaust, intake, and compression strokes, combustion of fuel within cylinders 22 may rotate a crankshaft (not shown) to produce mechanical power. The gaseous fuel and air required for combustion may be supplied to each cylinder 22 through a first intake passage 30 connected to first bank 26, a second intake passage 32 connected to second bank 28, and a common intake passage 40. First and second intake passages 30, 32 may each include one or more passages fluidly connecting common intake passage 40 with each cylinder 22 of first and second banks 26, 28. For example, first intake passage 30 may include a first intake manifold fluidly connecting common intake passage 40 with first bank 26 of cylinders 22, and second intake passage 32 may include a second intake manifold fluidly connecting common intake passage 40 with second bank 28 of cylinders 22. The air/gaseous fuel mixture delivered to cylinders 22 may require an ignition source for combustion to occur. In one embodiment, in which engine 12 is a dual-fuel engine, a compression-ignited fuel (e.g., diesel fuel) may be injected into cylinders 22 via liquid-fuel injectors 34 to initiate combustion of the air/gaseous fuel mixture. In another embodiment, an electric spark may be used as the ignition source.

Intake system 14 may include a plurality of gaseous-fuel injectors 36, 38 configured to inject gaseous fuel into first and second intake passages 30, 32. For example, gaseous-fuel injectors 36, 38 may include a first fuel injector 36 configured to inject gaseous fuel into first intake passage 30 and a second fuel injector 38 configured to inject gaseous fuel into second intake passage 32. First and second intake passages 30, 32 may deliver the gaseous fuel to cylinders 22, along with a flow of charged air. In other embodiments, a plurality of gaseous-fuel injectors may be configured to inject gaseous fuel individually into each cylinder 22.

Intake system 14 may further include components configured to introduce the charged air into engine 12. For example, intake system 14 may include a compressor 44. Compressor 44 may embody a fixed displacement compressor, a centrifugal compressor, or any other type of compressor configured to receive air from a fluid passage 46, and to compress the air to a predetermined pressure level before it enters engine 12. Compressor 44 may be connected to engine 12 via common intake passage 40 and first and second intake passages 30 and 32, and may be mechanically powered by the crankshaft (not shown), or some other means.

Exhaust system 16 may include components configured to manage exhaust flow from engine 12 to the atmosphere. Specifically, exhaust system 16 may include first and second exhaust passages 50, 52 in fluid communication with combustion chambers 24, a common exhaust passage 56, and a turbine 58 associated with common exhaust passage 56. First and second exhaust passages 50, 52 may each include one or more passages fluidly connecting first and second banks 26, 28 of cylinders 22 with common exhaust passage 56. For example, first exhaust passage 50 may include a first exhaust manifold fluidly connecting first bank 26 of cylinders 22 with common exhaust passage 56 and second exhaust passage 52 may include a second exhaust manifold fluidly connecting second bank 28 of cylinders 22 with common exhaust passage 56. Energy removed from the exhaust exiting engine 12 may be utilized to compress inlet air. Specifically, compressor 44 and turbine 58 may together form a turbocharger 60 driven by exhaust from common exhaust passage 56.

FIG. 2 depicts another exemplary power system 10, in which exhaust system 16 may also include an exhaust gas recirculation (EGR) circuit 53. EGR circuit 53 may further include components that cooperate to redirect a portion of the exhaust produced by engine 12 from first and second exhaust passages 50, 52 to intake system 14. Specifically, EGR circuit 53 may include a primary EGR passage 54 having one or more inlet ports 62 and a discharge port 64. EGR circuit 53 may also include a secondary EGR passage 66 fluidly connecting first exhaust passage 50 to second intake passage 32. Inlet ports 62 may be fluidly connected to first and second exhaust passages 50, 52 to receive high-pressure exhaust at elevated temperatures in parallel with turbine 58 (i.e., to receive exhaust that has not yet passed through turbine 58). Discharge port 64 may discharge exhaust into intake system 14, such as through common intake passage 40 to both of first and second intake passages 30, 32. Secondary EGR passage 66 may receive some of the high-pressure exhaust from first bank 26 of cylinders 22 and distribute the exhaust to only second bank 28 of cylinders 22 via second intake passage 32.

As depicted in both FIGS. 1 and 2, control system 18 may include components configured to control the delivery of air, fuel, and exhaust to cylinders 22. Specifically, control system 18 may include a controller 68 in communication with a variable orifice 70, liquid-fuel injector 34, and first and second gaseous fuel injectors 36, 38. Controller 68 may be configured to electronically manage the flow of air, fuel, and exhaust based on a signal from one or more sensors 72.

Controller 68 may include one or more computing devices such as a one or more microprocessors. For example, controller 68 may embody a general microprocessor capable of controlling numerous machine or engine functions. Controller 68 may also include all of the components required to run an application such as, for example, a computer-readable memory, a secondary storage device, and a processor, such as a central processing unit or any other means known. Various other known circuits may be associated with controller 68, including power source and other appropriate circuitry.

Variable orifice 70 may be disposed within second intake passage 32 and configured to adjust the flow of air and exhaust (referring to FIG. 2) through second intake passage 32. Variable orifice 70 may be a device selectively movable by controller 68 to adjust an effective cross-sectional area of second intake passage 32. Variable orifice 70 may be a throttle-type device, such as a plate, gate, butterfly valve, adjustable aperture, or any other variable restriction device.

As depicted in the exemplary embodiment of FIG. 1, a single variable orifice 70 may be located inside second intake passage 32, downstream of the location where common intake passage 40 branches into first and second intake passages 30 and 32. As depicted in the embodiment of FIG. 2, the location of variable orifice 70 may also be downstream of where primary EGR passage 54 introduces recirculated exhaust into common intake passage 40. Variable orifice 70, in both embodiments, may be located upstream from gaseous-fuel injectors 36 and 38. In this way, variable orifice 70 may be arranged to restrict the flow of charged air (and recirculated exhaust) through second intake passage 32. The reduced air flow through second intake passage 32 may result in an increased air flow through first intake passage 30. Therefore, movement of variable orifice 70 to selectively restrict the charged air through only second intake passage 32 may adjust the air delivery in both first and second intake passages 30, 32, to thereby affect the air/fuel ratio in both first and second passages 30, 32. For example, movement of variable orifice 70 may increase air flow through first intake passage 30 (increasing the air/fuel ratio for a constant amount of fuel), and decrease air flow through second intake passage 32 (decreasing the air/fuel ratio for a constant amount of fuel). While only one variable orifice 70 is depicted in FIG. 1, it is contemplated that any number or variable orifices 70 may be implemented as part of intake system 14 and control system 18.

Sensor(s) 72 may take any form of sensor(s) disposed on or near engine 12. Sensor(s) 72 may be configured to provide feedback and/or feed-forward signals to controller 68 for control of power system 10. For example, sensor(s) 72 may be configured to measure a speed of engine 12 and/or a constituent of exhaust produced by power system 10. That is, two sensors 72 may be provided, including an engine speed sensor 72A and an oxygen sensor 72B configured to detect an amount of oxygen in first and second exhaust passages 50, 52.

### INDUSTRIAL APPLICABILITY

The disclosed control system 18 may be implemented into any power system application where flow and mixing ratio of multiple fluids may need to be controlled. The disclosed control system 18 may be particularly useful in managing a flow of fuel, air, and/or exhaust entering an engine 12. In particular, the exemplary disclosed control system 18 may allow for control of air, fuel, and/or exhaust flowing into different subsets of cylinders 22 (e.g., first bank 26 and second bank 28) for producing different operating and performance characteristics within the different groups. This capability may help to increase power system efficiency at all loads. Various strategies for utilizing control system 18 are described below.

In one exemplary control strategy, control system 18 may be utilized to reduce the number of combustion events within cylinders 22 to match low load conditions to the air/fuel ratio optimized for higher load conditions. For example, when engine 12 is operated at higher loads, controller 68 may adjust variable orifice 70 to an open position so that flow of air into first and second intake passages 30, 32 is approximately equal. In addition, controller 68 may direct gaseous-fuel injectors 36, 38 to inject an amount of fuel according to a particular schedule to produce an efficient air/fuel ratio for engine 12 at higher loads. In this way, engine 12 may be tuned to run efficiently at higher loads with little or no restriction of air flow by variable orifice 70

However, as a load on engine 12 varies and begins to decrease, control system 18 may determine that variable orifice 70 should be moved to restrict air flow through exhaust passage 50 and that the timing of fuel injectors 34, 36, 38 and/or quantity of injected fuel should be adjusted. Such a control strategy may be managed based on signals from sensors 72, such as a signal from speed sensor 72A. For example, for a given engine speed, controller 68 may be able to determine the ratio of air-to-fuel that should be directed into each of first and second intake passages 30, 32.

As load decreases, the signal from speed sensor 72A (e.g., indicating a speed of engine 12 above a threshold) may indicate to controller 68 that that the air/fuel ratio delivered to each cylinder 22 may need to be increased because the mixture is too lean for efficient combustion. At low loads, the portion of the load on each cylinder 22 may be too low for efficient combustion. As an example, combustion may be inefficient (or not occurring at all) within one or more cylinders 22, for example, for an air/fuel ratio greater than about 2 (i.e. about 2× the stoichiometric air/fuel ratio of a particular fuel).

To address this problem, controller 68 may reduce the air flow to some cylinders 22 (such as those in second bank 28) and redirect the air to other cylinders 22 (such as those in first bank 26). The reduction in air flow may allow for a richer air/fuel ratio and, thus, more efficient combustion. Therefore, when engine 12 is subject to lower loads or is idling, controller 68 may be configured to adjust variable orifice 70 to restrict the flow of air to second bank 28 such that the power produced by the second bank 28 of cylinders 22 may be sufficient to match the power requirements of engine 12 at lower loads. To redirect the air flow in this way, controller 68 may move variable orifice 70 to restrict the flow of charged air to second intake passage 32 to thereby decrease the air/fuel ratio delivered to second bank 28 of cylinders 22. Controller 68 may monitor a signal from oxygen sensor 72B to detect an amount of oxygen and determine if additional movement of variable orifice 70 is necessary based on the amount of oxygen (e.g., if the air/fuel ratio has not been sufficiently adjusted).

Meanwhile, in one example, some or all of the cylinders 22 receiving the redirected air may be turned off (e.g., by not directing any fuel to them) such that they are not operated inefficiently. For example, controller 68 may direct gaseous fuel injector 36 (and corresponding liquid-fuel injectors 34) not to inject fuel for given engine cycles. The remaining air may flow through first intake passage 30, into cylinders 22 of first bank 26, and into first exhaust passage 50. At least some of the air will flow through common exhaust passage 56 to power turbine 58 of turbocharger 60. Therefore, the first bank 26 of cylinders 22 may be utilized to only move air through engine 12.

In another example, cylinders 22 of first bank 26 may be skip fired, such as by injecting an amount of gaseous fuel large enough to produce an efficient air/fuel ratio, but only for some engine cycles (i.e., skipping combustion during other engine cycles). Thus, rather than multiple consecutive small injections, which result in all combustion events being at low and inefficient loads, some cycles may be skipped (e.g., by not injecting fuel or igniting the air/fuel mixture). By increasing the amount of fuel injected during the cycles that are not skipped, more efficient combustion events for particular loads may be possible.

As the load on engine 12 increases, sensor 72A may signal to controller 68 that cylinders 22 of first bank 26 are again needed to match the power requirements. Controller 68 may move variable orifice 70 to increase the flow of charged air through second intake passage 32. Controller 68 may again monitor signals from sensor 72B to determine if the air/fuel ratio has been sufficiently adjusted. For example, controller 68 may produce a signal to move variable orifice 70 to allow more air to flow through second intake passage 32, thus changing the relative flow rates of air to first and second intake passages 30, 32. Controller 68 may also readjust the timing of gaseous-fuel injectors 36, 38 and liquid-fuel injectors 34 to match the air flow rate to produce a desired air/fuel ratio in each of first and second intake passages 30, 32.

Engine 12 may utilize variable orifice 70 to strategically control the air/fuel ratio delivered to each cylinder 22 of first and second banks 26, 28. For example, controller 68 may utilize a control map to incrementally adjust the variable orifice 70 between opened and closed positions and the timing of fuel injectors 34, 36, 38 in accordance with performance parameters indicated by signals from sensors 72 to produce a desired air/fuel ratio delivered to each cylinder 22.

In another exemplary use for control system 18, variable orifice 70 may be selectively adjusted to allow for optional operation between lean and rich fuel operations. For instance, variable orifice 70 may control the air flow rate into each of first bank 26 and second bank 28 of cylinders 22 such that fuel may be injected into first bank 26 of cylinders 22 (without injecting fuel into second bank 28 of cylinders 22) for a lean fuel operation mode (since the air flow rate is larger), or fuel may be injected into second bank 28 of cylinders 22 (without injecting fuel into first bank 26 of cylinders 22) for a rich fuel operation mode (since the air flow rate is smaller). In this way, engine 12 may be optionally utilized to meet varying performance characteristics.

In another exemplary control strategy utilizing exhaust system 16 depicted in FIG. 2, control system 18 may utilize a pressure differential created by variable orifice 70 to drive exhaust from first exhaust passage 50 to second intake passage 32 through secondary EGR passage 66. For example, controller 68 may move variable orifice 70 to decrease the flow of charged air through second intake passage 32 and increase a corresponding flow through first intake passage 30, resulting in a pressure differential between first intake and exhaust passages 30, 50 and second intake and exhaust passages 32, 52.

Secondary EGR passage 66 may be selectively opened by controller 68 when variable orifice 70 is in a position that produces a sufficient pressure differential to drive exhaust through secondary EGR passage 66 (i.e., a pressure in first exhaust passage 50 is higher than a pressure in second intake passage 32). In this way, exhaust may be distributed between first bank 26 and second bank 28 of cylinders 22. In other embodiments, controller 68 may adjust variable orifice 70 to distribute exhaust through primary EGR passage 54 and/or secondary EGR passage 66 to separately control the amount of recirculated exhaust directed to first and second banks 26, 28 of cylinders 22.

Independently distributing exhaust to first bank 26 and second bank 28 of cylinders 22 may allow for more efficient redistribution of exhaust for subsequent combustion. For example, exhaust from first bank 26 (which may be skipping combustion cycles due to a leaner air/fuel mixture) may be distributed by pressure differential to second bank 28 for subsequent combustion. Selectively distributing exhaust in this manner may allow for overall reduced emissions since the air/fuel ratio may be further controlled to produce more efficient combustion (e.g., with reduced exhaust ultimately being let out to the atmosphere).

It will be apparent to those skilled in the art that various modifications and variations can be made to the control system of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A control system for an engine, comprising:
a first gaseous-fuel injector configured to inject gaseous fuel into a first intake passage associated with at least a first cylinder;
a second gaseous-fuel injector configured to inject gaseous fuel into a second intake passage associated with at least a second cylinder;
a variable orifice disposed within the second intake passage upstream of the first gaseous fuel injector;
a sensor configured to provide a signal indicative of a performance parameter of the engine; and
a controller electronically connected to the variable orifice and the sensor, wherein the controller is configured to move the variable orifice to adjust an air/fuel ratio in the first and second intake passages based on the signal.

2. The control system of claim 1, wherein the controller is electronically connected to the first gaseous-fuel injector and the second gaseous-fuel injector.

3. The control system of claim 2, further including at least one liquid-fuel injector, wherein the controller is electronically connected to the at least one liquid-fuel injector.

4. The control system of claim 1, wherein the variable orifice is disposed downstream of an air compressor.

5. The control system of claim 1, wherein the sensor is a speed sensor configured to measure a speed of the engine.

6. The control system of claim 1, wherein the sensor is an oxygen sensor.

7. The control system of claim 1, wherein the variable orifice is configured to create a pressure differential between an exhaust passage of the first cylinder and the second intake passage.

8. The control system of claim 7, wherein the controller is configured to move the variable orifice to use the pressure differential to drive exhaust from the exhaust passage of the first cylinder to the second cylinder through the second intake passage.

9. The control system of claim 1, further including a primary EGR passage fluidly connecting a first exhaust passage of the first cylinder and a second exhaust passage of the second cylinder with the first and second intake passages, wherein the primary EGR passage is configured to introduce exhaust from the first and second cylinders into the first and second intake passages.

10. The control system of claim 9, wherein the primary EGR passage is configured to introduce exhaust into the first and second intake passages upstream of the variable orifice.

11. The control system of claim 9, further including a secondary EGR passage directly fluidly connecting the first exhaust passage with the second intake passage.

12. A method of controlling an air/fuel ratio of engine, comprising:
directing charged air into a first intake passage and into a second intake passage in parallel;
injecting gaseous fuel into each of the first and second intake passages; and
moving a variable orifice to selectively restrict charged air flow through only the second intake passage and thereby affect the air/fuel ratio in both the first and second intake passages.

13. The method of claim 12, further including adjusting the injection of gaseous fuel into the second intake passage to further adjust the air/fuel ratio in the second intake passage.

14. The method of claim 12, further including ceasing injecting gaseous fuel into the first intake passage after moving the variable orifice to turn off a subset of cylinders of the engine.

15. The method of claim 12, further including detecting an engine speed and moving the variable orifice in response to a detection of an engine speed relative to a threshold level.

16. The method of claim 15, further including detecting an amount of oxygen in an exhaust passage and determining if additional movement of the variable orifice is necessary based on the amount of oxygen.

17. The method of claim 12, wherein injecting gaseous fuel into the second intake passage occurs downstream of the variable orifice.

18. The method of claim 12, further including moving the variable orifice to create a pressure differential between the second intake passage and an exhaust passage connected to the first intake passage.

19. The method of claim 18, further including driving exhaust from the exhaust passage to the second intake passage via the pressure differential.

20. An engine, comprising:
an engine block;
a first bank of cylinders;
a second bank of cylinders;
a first intake manifold configured to supply fuel and air to the first bank;
a second intake manifold configured to supply fuel and air to the second bank;
a first exhaust manifold configured to receive exhaust from the first bank;
a second exhaust manifold configured to receive exhaust from the second bank;
a first gaseous-fuel injector configured to inject gaseous fuel into the first intake manifold;
a second gaseous-fuel injector configured to inject gaseous fuel into the second intake manifold;
a variable orifice disposed within the second intake manifold upstream of the first gaseous fuel injector;
a sensor configured to provide a signal indicative of a performance parameter of the engine; and
a controller electronically connected to the variable orifice and the sensor, wherein the controller is configured to move the variable orifice to adjust an air/fuel ratio in the first and second intake manifolds based on the signal.
